(19) United States
(12) Patent Application Publication
(10) Pub. No.: US 2016/0219902 A1
(43) Pub. Date: Aug. 4, 2016

(54) LEAVENED CHEW BONE FOR PETS AND METHOD FOR PREPARING THE SAME

(71) Applicant: Wenzhou Yuxiang Pet Product Co., Ltd., Wenzhou City (CN)

(72) Inventors: Zuhua CHEN, Wenzhou City (CN); Zuxi CHEN, Wenzhou City (CN)

(21) Appl. No.: 14/690,466

(22) Filed: Apr. 19, 2015

(30) Foreign Application Priority Data
Jan. 29, 2015 (CN) 201510045807.1

(51) Int. Cl. A23K 1/00; A23K 1/175; A23K 1/14; A23K 1/16; A23K 1/18; A23K 1/10

(52) U.S. Cl. CPC A23K 1/007; A23K 1/1853; A23K 1/10; A23K 1/14; A23K 1/1603; A23K 1/175

(57) ABSTRACT

A leavened chew bone for pets and a method for preparing the leavened chew bone use wheat gluten, corn starch, and chicken or/and beef as main materials. The method involves steps of (1) dissolving, (2) activating yeast powder, (3) mixing, (4) slurry making, (5) fermenting and toughening, (6) forming, (7) leavening, and (8) heat-drying. The leavened chew bone such made is highly nutritional and has controlled hardness.

### BACKGROUND OF THE INVENTION

(a) Technical Field of the Invention

The present invention relates to chew bone for pets, and more particularly to a leavened chew bone and a method for preparing the leavened chew bone.

(b) Description of the Prior Art

The conventional leavened chew bones are made of cow split leather and have some shortcomings. First, cow split leather is increasingly short at its sources, making this material costly and less competitive. Secondary, chew bones made of cow split leather in relatively inflexible in terms of hardness, and may damage pets using them. At last, chew bones made of cow split leather only act as chew toys with less nutrition and are likely to be too hard for comfortable chewing.

### SUMMARY OF THE INVENTION

For improving the prior art, the objective of the present invention is to provide a leavened chew bone for pets that is highly nutritional, inexpensive to make and controllable in terms of hardness, as well as a method for preparing the leavened chew bone.

For achieving the foregoing objective, the present invention implements the following technical scheme: a leavened chew bone for pets, the leavened chew bone being characterized in comprising the following materials by weight parts: 50-80 parts of wheat gluten, 5-20 parts of corn starch, 16-25 parts of chicken or/and beef, 10-20 parts of meat-bone powder, 5-20 parts of food-grade glycerin, 2-10 parts of food-grade gelatin, 1-2 parts of yeast powder, 0.2-5 parts of food-grade flavoring, 0.2-5 parts of DL-alanine, 0.1-1 part of culinary salt, 0.01-1 parts of sodium dihydrogen phosphate, 0.5-1 part of potassium chloride, 0.03-0.08 part of an anti-oxidant, 0.1-0.5 part of vitamins, and 0.02-1.5 parts of dietary minerals.

In the technical scheme of the present invention, the leavened chew bone further comprises 0.3-5.5 parts of food colouring.

With the aforementioned scheme, the disclosed leavened chew bone is well-balanced nutrition and contains both plant protein and animal protein. The other auxiliary materials also have beneficial effects. DL-alanine acts as a harmonizing agent that helps to mitigate the acidy taste form organic acids, and participates in pets' metabolism, thereby preventing pets from obesity caused by over-ingesting calories and thereby improving nourishment. Gelatin is a fat-free, cholesterol-free and high-protein food thickening agent derived from natural sources. It promotes emulsification of animal protein and helps digestion, while improving toughness and hardness of products. Sodium dihydrogen phosphate is a common quality modifier used in pet foods. It helps to achieve body fluid's acid-base balance. Particularly, phosphorus oxide participates in the formation of DNA, RNA and many coenzymes during acid metabolism. Bone meal is mainly composed of tricalcium phosphate, bone gelatin and fat, and is full of dietary minerals and chondroitin. Bone gelatin is essential for pets' brain development, and has excellent anti-aging effects. Potassium chloride is effective in improving animal protein's water-holding capacity, inhibiting microorganisms' growth, increasing protein's dissolubility, and mitigating adverse effects of excessive sodium on pets. Vitamins are essential for organisms' metabolism. It helps to maintain visual health, promote bone formation and enhance absorption of calcium and phosphorous, making pets' have good gastrointestinal and dermatologic health and immunity. Dietary minerals are helpful to health of bones and teeth, to synthesis of protein and to balance of body moisture. The anti-oxidant is used to prevent or defer spoilage by oxidation and helps to improve stability and shelf life of the products. Otherwise, if the products are oxidized to the extent that the fat contained therein deteriorates to spoil vitamins, noxious substance may generate to make the products uneatable.

The method for preparing the disclosed leavened chew bone is characterized in comprising the following steps:

(1) Dissolving: mixing gelatin and culinary salt with water respectively at a ratio of 1:1-1:1.5 into a mixture, transferring the mixture into a stainless steel container, and heating the mixture at 50-80° C. by double boiling while stirring the mixture until the materials are completely dissolved;

(2) Activating yeast powder: dissolving yeast in warm water at 35° C.-45° C. into a solution for activation, wherein a ratio between the yeast powder and the water is 1:1.5-1:2, and letting the solution stand for 10-20 minutes to allow the yeast powder to be fully activated;

(3) Mixing: mixing wheat gluten, 60%-80% of corn starch, chicken or/and beef powder, meat-bone powder, DL-alanine, sodium dihydrogen phosphate, potassium chloride, an anti-oxidant, vitamins, and dietary minerals evenly using a mixer for later use;

(4) Slurry making: diluting the rest of the corn starch with 3-4 times of water, stirring the corn starch and the water in a stainless steel tank until the corn starch is completely dispersed in the water, heating the corn starch and the water by double boiling while stirring for 15-30 minutes, adding glycerin, food-grade flavoring, melted culinary salt, and melted gelatin in order during the heating and stirring so as to form a mixture, and stopping heating and stirring when the mixture clearly shows viscous colloid;

(5) Fermenting and toughening: placing the mixed materials of Step (3) into a stainless steel flour-mixing machine, mixing the mixed materials while adding the slurry of Step (4), mixing for 10-20 minutes, evenly and slowly add the activated yeast powder of Step (2) into the materials for mixing and toughening for at least half an hours until the materials forms a dough, and placing the dough in a natural condition for further fermenting for 15-20 minutes;

(6) Forming: dividing the dough of Step (5) into small dough balls and rubbing the dough balls for 5-10 minutes to make the dough balls more compact, soft and tough, placing the dough balls into a dough sheeter to make dough sheets, using molds to press the dough sheets into dough pieces of different dimensions, and making the dough pieces into bone-shaped semi-products;

(7) Leavening: placing the semi-products of Step (6) in a natural condition for leavening the semi-products for at least 3 hours to see the semi-products leavened, processing the semi-products in an autoclave at 80-130 mpa for 10 minutes to make the semi-products further mature and leavened; and

(8) Heat-drying: heat-drying the semi-products of Step (7) until a moisture content therein is less than 13%, and performing final sterilization. In the technical scheme of the present invention, the method uses the chicken or/and beef is/are fresh chicken or/and fresh beef that has/have been processed into meat slurry by a meat grinder.

With the foregoing scheme, the method is easy to perform. Therein, the yeast powder when mixed with starch can generate a large amount of carbon dioxide, which makes the materials to raise into a spongy-like structure so as to achieve leavening. It is to be noted that after the yeast powder is activated, the materials need to be added timely unless the expected leavening may become unachievable. In addition, when performing ferment, the yeast powder generates a large amount of small-molecule flavor substances, such as amino acid, oligosaccharide, esters and alcohols, making the resultant leavened chew bone taste good. Besides, the yeast powder contains enzymes that can hydrolyze starch, cellulose and protein into low-molecular substance, making the nutrition of the leavened chew bone easy to digest and absorb by pets. The yeast powder further has phytase that effectively hydrolyzes phytate in wheat-based foods and helps organisms to absorb zinc, iron and calcium. At last, yeast is a kind of single-cell protein, and is full of protein and B vitamins. It is useful to promote pets' growth and development, to improve the gloss of pets' fur, and to increase young dogs' disease resistance. The present invention will be further explained in the following description.

### DETAILED DESCRIPTION OF THE PREFERRED EMBODIMENTS

A leavened chew bone for pets comprises the following materials by weight parts: 50-80 parts of wheat gluten, 5-20 parts of corn starch, 16-25 parts of chicken or/and beef, 10-20 parts of meat-bone powder, 5-20 parts of food-grade glycerin, 2-10 parts of food-grade gelatin, 1-2 parts of yeast powder, 0.2-5 parts of food-grade flavoring, 0.2-5 parts of DL-alanine, 0.1-1 part of culinary salt, 0.01-1 parts of sodium dihydrogen phosphate, 0.5-1 part of potassium chloride, 0.03-0.08 part of an anti-oxidant, 0.1-0.5 part of vitamins, and 0.02-1.5 parts of dietary minerals. As needed, the leavened chew bone may further comprise 0.3-5.5 parts of food colouring. The chicken or/and beef powder may be fresh chicken or fresh beef that has been processed into meat slurry by a meat grinder. With the foregoing scheme, the disclosed leavened chew bone well-balanced nutrition contains both plant protein and animal protein. Therein, the corn starch supports the overall molecular structure. The other auxiliary materials also have beneficial effects. DL-alanine acts as a harmonizing agent that helps to mitigate the acidy taste form organic acids, and participates in pets' metabolism, thereby preventing pets from obesity caused by over-ingesting calories and thereby improving nourishment. Gelatin is a fat-free, cholesterol-free and high-protein food thickening agent derived from natural sources. It promotes emulsification of animal protein and helps digestion, while improving toughness and hardness of products. Sodium dihydrogen phosphate is a common quality modifier used in pet foods. It helps to achieve body fluid's acid-base balance. Particularly, phosphorus oxide participates in the formation of DNA, RNA and many coenzymes during acid metabolism. Bone meal is mainly composed of tricalcium phosphate, bone gelatin and fat, and is full of dietary minerals and chondroitin. Bone gelatin is essential for pets' brain development, and has excellent anti-aging effects. Potassium chloride is effective in improving animal protein's water-holding capacity, inhibiting microorganisms' growth, increasing protein's dissolubility, and mitigating adverse effects of excessive sodium on pets. Vitamins are essential for organisms' metabolism. It helps to maintain visual health, promote bone formation and enhance absorption of calcium and phosphorous, making pets' have good gastrointestinal and dermatologic health and immunity. Dietary minerals are helpful to health of bones and teeth, to synthesis of protein and to balance of body moisture. The anti-oxidant is used to prevent or defer spoilage by oxidation and helps to improve stability and shelf life of the products. Otherwise, if the products are oxidized to the extent that the fat contained therein deteriorates to spoil vitamins, noxious substance may generate to make the products uneatable.

According to one embodiment of the present invention, a method for preparing the leavened chew bone comprises the following steps:

(1) Dissolving: mixing gelatin and culinary salt with water respectively at a ratio of 1:1-1:1.5 into a mixture, transferring the mixture into a stainless steel container, and heating the mixture at 50-80° C. by double boiling while stirring the mixture until the materials are completely dissolved;

(2) Activating yeast powder: dissolving yeast in warm water at 35° C.-45° C. into a solution for activation, wherein a ratio between the yeast powder and the water is 1:1.5-1:2, and letting the solution stand for 10-20 minutes to allow the yeast powder to be fully activated;

(3) Mixing: mixing wheat gluten, 60%-80% of corn starch, chicken or/and beef powder, meat-bone powder, DL-alanine, sodium dihydrogen phosphate, potassium chloride, an anti-oxidant, vitamins, and dietary minerals evenly using a mixer for later use;

(4) Slurry making: diluting the rest of the corn starch with 3-4 times of water, stirring the corn starch and the water in a stainless steel tank until the corn starch is completely dispersed in the water, heating the corn starch and the water by double boiling while stirring for 15-30 minutes, adding glycerin, food-grade flavoring, melted culinary salt, and melted gelatin in order during the heating and stirring so as to form a mixture, and stopping heating and stirring when the mixture clearly shows viscous colloid;

(5) Fermenting and toughening: placing the mixed materials of Step (3) into a stainless steel flour-mixing machine, mixing the mixed materials while adding the slurry of Step (4), mixing for 10-20 minutes, evenly and slowly add the activated yeast powder of Step (2) into the materials for mixing and toughening for at least half an hours until the materials forms a dough, and placing the dough in a natural condition for further fermenting for 15-20 minutes;

(6) Forming: dividing the dough of Step (5) into small dough balls and rubbing the dough balls for 5-10 minutes to make the dough balls more compact, soft and tough, placing the dough balls into a dough sheeter to make dough sheets, using molds to press the dough sheets into dough pieces of different dimensions, and making the dough pieces into bone-shaped semi-products;

(7) Leavening: placing the semi-products of Step (6) in a natural condition for leavening the semi-products for at least 3 hours to see the semi-products leavened, processing the semi-products in an autoclave at 80-130 mpa for 10 minutes to make the semi-products further mature and leavened; and

(8) Heat-drying: heat-drying the semi-products of Step (7) until a moisture content therein is less than 13%, and performing final sterilization. In one embodiment of the present invention, the chicken or/and beef is/are fresh chicken or/and fresh beef that has/have been processed into meat slurry by a meat grinder. Of course, fresh chicken powder or/and fresh beef powder may be used instead, so as to omit the step of grinding.

With the foregoing scheme, the method is easy to perform. Therein, the yeast powder when mixed with starch can generate a large amount of carbon dioxide, which makes the materials to raise into a spongy-like structure so as to achieve leavening. It is to be noted that after the yeast powder is activated, the materials need to be added timely unless the expected leavening may become unachievable. In addition, when performing ferment, the yeast powder generates a large amount of small-molecule flavor substances, such as amino acid, oligosaccharide, esters and alcohols, making the resultant leavened chew bone taste good. Besides, the yeast powder contains enzymes that can hydrolyze starch, cellulose and protein into low-molecular substance, making the nutrition of the leavened chew bone easy to digest and absorb by pets. The yeast powder further has phytase that effectively hydrolyzes phytate in wheat-based foods and helps organisms to absorb zinc, iron and calcium. At last, yeast is a kind of single-cell protein, and is full of protein and B vitamins. It is useful to promote pets' growth and development, to improve the gloss of pets' fur, and to increase young dogs' disease resistance.

I claim:

1. A leavened chew bone for pets, the leavened chew bone being characterized in comprising the following materials by weight parts: 50-80 parts of wheat gluten, 5-20 parts of corn starch, 16-25 parts of chicken or/and beef, 10-20 parts of meat-bone powder, 5-20 parts of food-grade glycerin, 2-10 parts of food-grade gelatin, 1-2 parts of yeast powder, 0.2-5 parts of food-grade flavoring, 0.2-5 parts of DL-alanine, 0.1-1 part of culinary salt, 0.01-1 parts of sodium dihydrogen phosphate, 0.5-1 part of potassium chloride, 0.03-0.08 part of an anti-oxidant, 0.1-0.5 part of vitamins, and 0.02-1.5 parts of dietary minerals.

2. The leavened chew bone of claim 1, being characterized in further comprising 0.3-5.5 parts of food colouring.

3. A method for preparing the leavened chew bone for pets of claim 1, being characterized in comprising the following steps:
(1) Dissolving: mixing gelatin and culinary salt with water respectively at a ratio of 1:1-1:1.5 into a mixture, transferring the mixture into a stainless steel container, and heating the mixture at 50-80° C. by double boiling while stirring the mixture until the materials are completely dissolved;
(2) Activating yeast powder: dissolving yeast in warm water at 35° C.-45° C. into a solution for activation, wherein a ratio between the yeast powder and the water is 1:1.5-1:2, and letting the solution stand for 10-20 minutes to allow the yeast powder to be fully activated;
(3) Mixing: mixing wheat gluten, 60%-80% of corn starch, chicken or/and beef powder, meat-bone powder, DL-alanine, sodium dihydrogen phosphate, potassium chloride, an anti-oxidant, vitamins, and dietary minerals evenly using a mixer for later use;
(4) Slurry making: diluting the rest of the corn starch with 3-4 times of water, stirring the corn starch and the water in a stainless steel tank until the corn starch is completely dispersed in the water, heating the the corn starch and the water by double boiling while stirring for 15-30 minutes, adding glycerin, food-grade flavoring, melted culinary salt, and melted gelatin in order during the heating and stirring so as to form a mixture, and stopping heating and stirring when the mixture clearly shows viscous colloid;
(5) Fermenting and toughening: placing the mixed materials of Step (3) into a stainless steel flour-mixing machine, mixing the mixed materials while adding the slurry of Step (4), mixing for 10-20 minutes, evenly and slowly add the activated yeast powder of Step (2) into the materials for mixing and toughening for at least half an hours until the materials forms a dough, and placing the dough in a natural condition for further fermenting for 15-20 minutes;
(6) Forming: dividing the dough of Step (5) into small dough balls and rubbing the dough balls for 5-10 minutes to make the dough balls more compact, soft and tough, placing the dough balls into a dough sheeter to make dough sheets, using molds to press the dough sheets into dough pieces of different dimensions, and making the dough pieces into bone-shaped semi-products;
(7) Leavening: placing the semi-products of Step (6) in a natural condition for leavening the semi-products for at least 3 hours to see the semi-products leavened, processing the semi-products in an autoclave at 80-130 mpa for 10 minutes to make the semi-products further mature and leavened; and
(8) Heat-drying: heat-drying the semi-products of Step (7) until a moisture content therein is less than 13%, and performing final sterilization.

4. The method of claim 3, being characterized in that the chicken or/and beef is/are fresh chicken or/and fresh beef that has/have been processed into meat slurry by a meat grinder.
